(19) United States
(12) Patent Application Publication
(10) Pub. No.: US 2014/0229695 A1
(43) Pub. Date: Aug. 14, 2014

(54) SYSTEMS AND METHODS FOR BACKUP IN SCALE-OUT STORAGE CLUSTERS

(71) Applicant: DELL PRODUCTS L.P., Round Rock, TX (US)

(72) Inventors: Abhijit Dinkar, San Jose, CA (US); Jacob Cherian, Austin, TX (US)

(73) Assignee: DELL PRODUCTS L.P., Round Rock, TX (US)

(21) Appl. No.: 13/765,819

(22) Filed: Feb. 13, 2013

(51) Int. Cl. G06F 3/06

(52) U.S. Cl. CPC G06F 3/065
USPC 711/162

(57) ABSTRACT

In accordance with embodiments of the present disclosure, a storage system may include a storage cluster comprising a plurality of network attached storage nodes, one or more backup devices communicatively coupled to the storage cluster, and a cluster-wide data server executing on the plurality of network attached storage nodes and configured to manage communication of backup data between the plurality of network attached storage nodes and the one or more backup devices.

### TECHNICAL FIELD

The present disclosure relates in general to information handling systems, and more particularly to backup in data storage systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To store a large amount of data accessible to multiple information handling systems in a network, network-attached storage (NAS) is often used. Typically, NAS implements file-level data storage coupled to a network providing data access to a heterogeneous group of client information handling systems. In some embodiments, NAS not only operates as a file server, but is specialized for this task either by its hardware, software, or configuration of those elements.

To protect stored data, data stored in NAS is often backed up to generate a duplicate copy in the event that the original data is lost. Such backup and restore from backup is often facilitated by Network Data Management Protocol (NDMP) data servers implemented by NAS systems and backup software that supports NDMP known as Data Management Application (DMA). Generally, when NDMP is used to facilitate backup, one of two configurations may generally be considered. The first known as “local backup configuration” is depicted in FIG. 1, and the second known as “three-way configuration” is depicted in FIG. 2. In the local backup configuration shown in FIG. 1, backup and restore data 108 flows between a NAS system 102 and a backup device 106 (e.g., one or more disk drives) directly. A control connection 110 between the NAS data server and the DMA 112 at a backup host 104 exists over a network. In the three-way configuration shown in FIG. 2, both the NDMP control connection 110 and NDMP data 108 flow over a network. Backup device 106 may be accessed remotely over the network via an NDMP data server 103 that implements a backup service.

A standard NDMP implementation, such as those discussed above, poses challenges for scalability in a scale-out clustered NAS system. The challenge occurs by the fact that NDMP as a protocol was developed to support monolithic file systems. With scale-out clustered NAS systems, standard NDMP implementations are unable to take advantage of the additional resources available in the hardware instances that form a logical NAS entity. For instance, the NDMP implementation on a single node of a NAS cluster may be inefficient in backing up the cluster with data distributed among multiple hardware instances, thus negatively affecting performance.

### SUMMARY

In accordance with the teachings of the present disclosure, the disadvantages and problems associated with backup scalable storage systems have been reduced or eliminated.

In accordance with embodiments of the present disclosure, a storage system may include a storage cluster comprising a plurality of network attached storage nodes, one or more backup devices communicatively coupled to the storage cluster, and a cluster-wide data server executing on the plurality of network attached storage nodes and configured to manage communication of backup data between the plurality of network attached storage nodes and the one or more backup devices.

In accordance with these and other embodiments of the present disclosure, a method may include instantiating a cluster-wide data server to execute on a plurality of network attached storage nodes defining a storage cluster and managing communication of backup data between the plurality of network attached storage nodes and one or more backup devices communicatively coupled to the storage cluster.

In accordance with these and other embodiments of the present disclosure, an article of manufacture may include a computer readable medium and computer-executable instructions carried on the computer readable medium. The instructions may be readable by one or more processors, the instructions, and may be configured to when read and executed, for causing the one or more processors to instantiate a cluster-wide data server to execute on a plurality of network attached storage nodes defining a storage cluster and manage communication of backup data between the plurality of network attached storage nodes and one or more backup devices communicatively coupled to the storage cluster.

Technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example NDMP local backup configuration implementation, as is known in the art;

FIG. 2 illustrates a block diagram of an example NDMP three-way configuration implementation, as is known in the art;

FIG. 3 illustrates a block diagram of an implementation of scale-out NAS using a local backup configuration with direct attached backup devices and employing a distributed NDMP data server, in accordance with embodiments of the present disclosure;

FIG. 4 illustrates a block diagram of an implementation of scale-out NAS using a local backup configuration with storage area network attached backup devices and employing a distributed NDMP data server, in accordance with embodiments of the present disclosure;

FIG. 5 illustrates a block diagram of an implementation of scale-out NAS using a three-way configuration and employing a distributed NDMP data server, in accordance with embodiments of the present disclosure;

FIG. 6 illustrates selected components of a distributed NDMP data server, in accordance with embodiments of the present disclosure; and

FIG. 7 illustrates a block diagram of an example information handling system, in accordance with embodiments of the present disclosure.

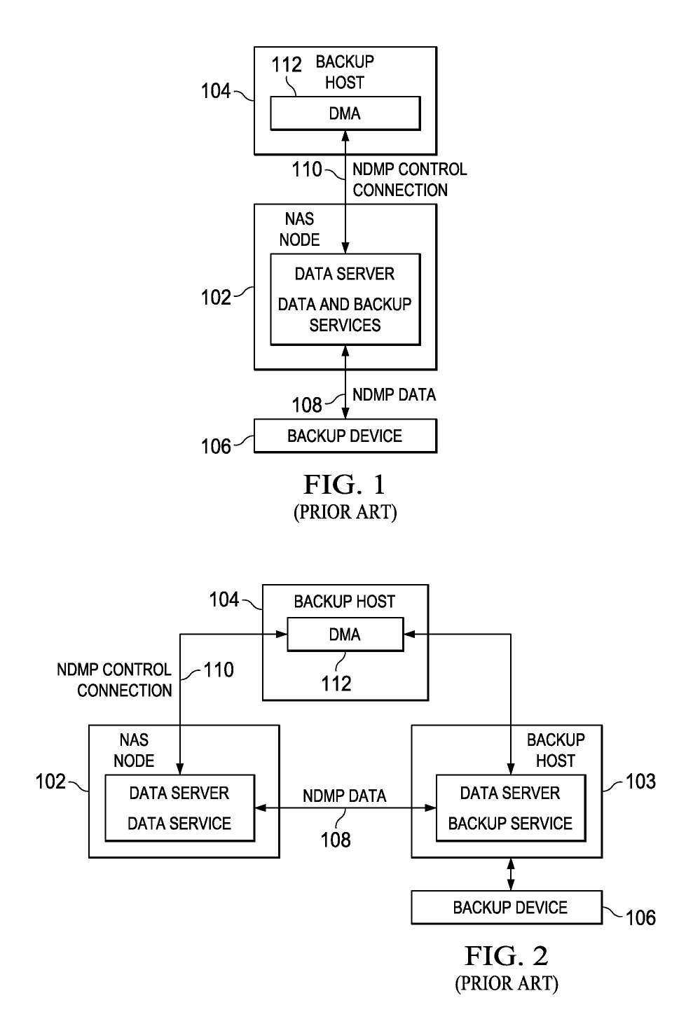

### DETAILED DESCRIPTION

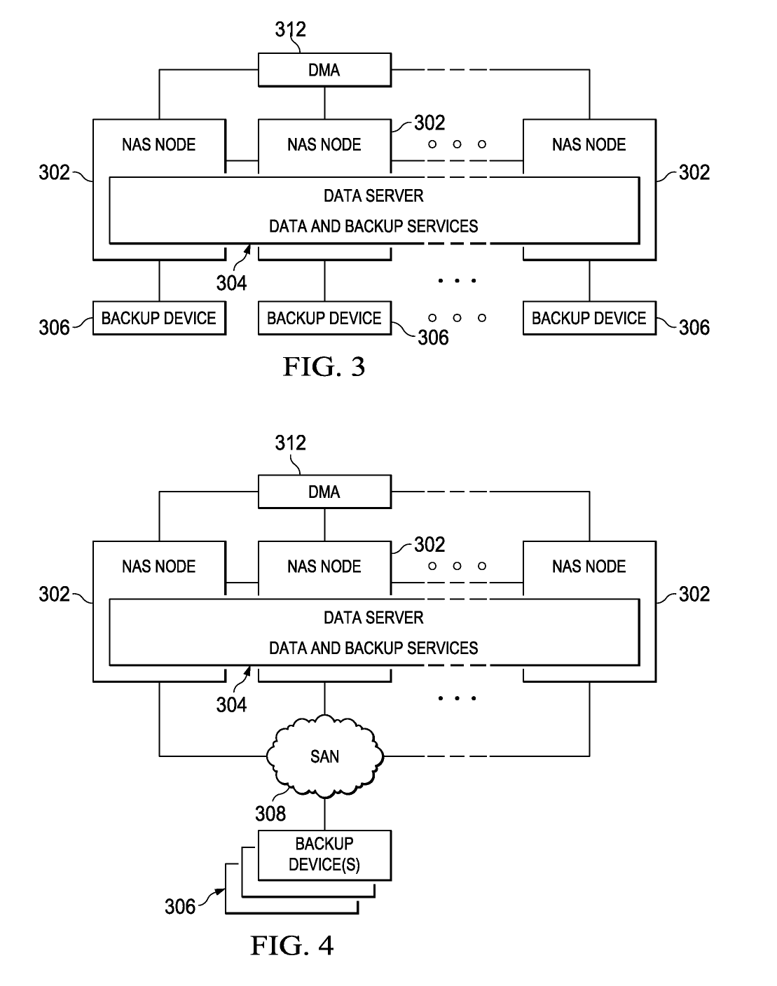

Preferred embodiments and their advantages are best understood by reference to FIGS. 3-7, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

An information handling system may include or may be coupled to an array of physical storage resources. The array of physical storage resources may include a plurality of physical storage resources, and may be operable to perform one or more input and/or output storage operations, and/or may be structured to provide redundancy. In operation, one or more physical storage resources disposed in an array of physical storage resources may appear to an operating system as a single logical storage unit or “virtual storage resource.” In particular embodiments, a virtual storage resource may be in the form of a network-attached storage (NAS) system in which the virtual storage resource is a file system that is accessed via a network.

In certain embodiments, an array of physical storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity generation/checking. As known in the art, RAIDs may be implemented according to numerous RAID levels, including without limitation, standard RAID levels (e.g., RAID 0, RAID 1, RAID 3, RAID 4, RAID 5, and RAID 6), nested RAID levels (e.g., RAID 01, RAID 03, RAID 10, RAID 30, RAID 50, RAID 51, RAID 53, RAID 60, RAID 100), non-standard RAID levels, or others. A virtual storage resource implemented as a NAS system may instantiates a file system on physical storage resources which may be RAID block storage or some other type of block storage.

FIG. 3 illustrates a block diagram of an implementation of scale-out NAS nodes 302 using a local backup configuration with direct attached backup devices 306 and employing a distributed NDMP data server 304, in accordance with embodiments of the present disclosure. In such implementation, individual NAS nodes 302 hosting distributed NDMP data server 304 may be directly coupled to associated backup devices 306. DMA 312 may communicate with each NAS node 302 via a network.

FIG. 4 illustrates a block diagram of an implementation of scale-out NAS nodes 302 using a local backup configuration with storage area network 308 attached to backup devices 306 and employing a distributed NDMP data server 304, in accordance with embodiments of the present disclosure. In such implementation, NAS nodes 302 hosting distributed NDMP data server 304 may be coupled to one or more backup devices 306 via a storage area network 308. DMA 312 may communicate with each NAS node 302 via a network.

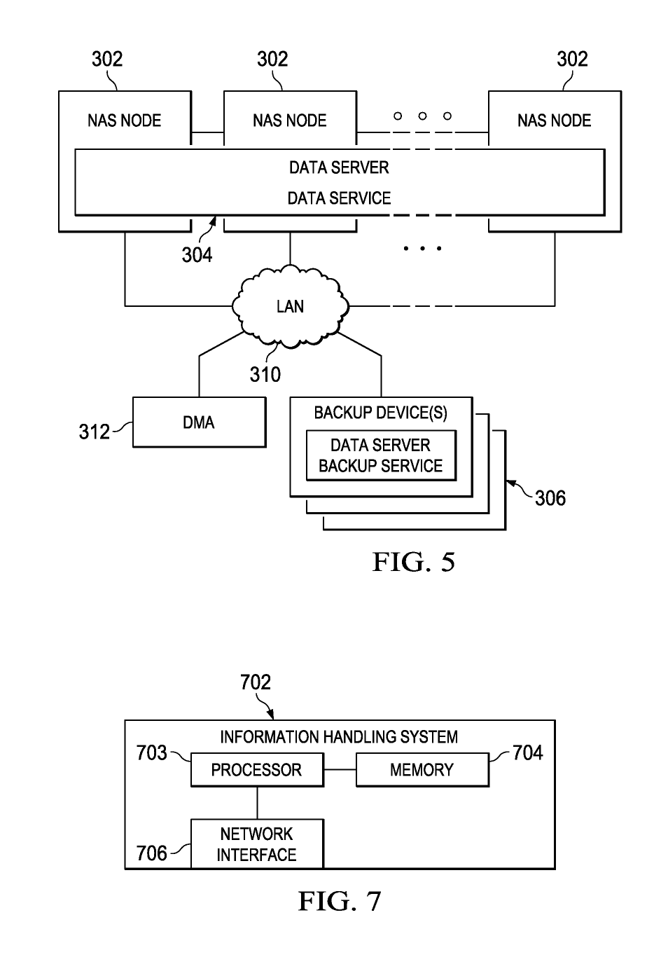

FIG. 5 illustrates a block diagram of an implementation of scale-out NAS nodes 302 using a three-way configuration and employing a distributed NDMP data server 304, in accordance with embodiments of the present disclosure. In such implementation, NAS nodes 302 hosting distributed NDMP data server 304 may be coupled to one or more backup devices 306 via a local area network 310. In addition, DMA 312 may communicate with NAS nodes 302 via local area network 310.

A NAS node 302, as depicted in FIGS. 3-5, may comprise any suitable information handling system for implementing network attached storage, including managing and/or controlling network attached storage services, including data and backup services, as described elsewhere in this disclosure. In some embodiments, a NAS node 302 may comprise a server. In these and other embodiments, a NAS node 302 may comprise computer-readable media (e.g., hard disk drives) for storing data.

A backup device 306, as depicted in FIGS. 3-5, may comprise any suitable computer-readable medium (e.g., hard disk drive, tape backup drive, etc.) for storing backup of data stored to NAS nodes 302.

A DMA 312, as depicted in FIGS. 3-5, may comprise any suitable system, device, or apparatus configured to manage, control, and/or coordinate backup of data from NAS nodes 302 to backup devices 306. In some embodiments, DMA 312 may comprise a program of instructions configured to execute on a processor. In these and other embodiments, DMA 312 may execute on a NAS node 302, a backup device 306, or an information handling system separate from NAS nodes 302 and backup devices 306.

A storage area network 308, as shown in FIG. 4, may comprise a network that provides access to consolidated, block level data storage of backup devices 306. In the embodiments represented by FIG. 4, storage area network 308 may allow backup devices 306 to present as locally attached devices to an operating system (e.g., an operating system executing on a NAS node 302). In some embodiments, storage area network 308 may be implemented using relevant Fibre Channel standards, Internet Small Computer System Interface (iSCSI) standards, or other suitable standards.

A local area network 310, as shown in FIG. 5, may comprise a network that interconnects information handling systems (e.g., NAS nodes 302 and backup devices 306) in a limited area such as a home, school, computer laboratory, or office building using network media. In some embodiments, local area network 310 may be implemented using relevant Internet Protocol standards.

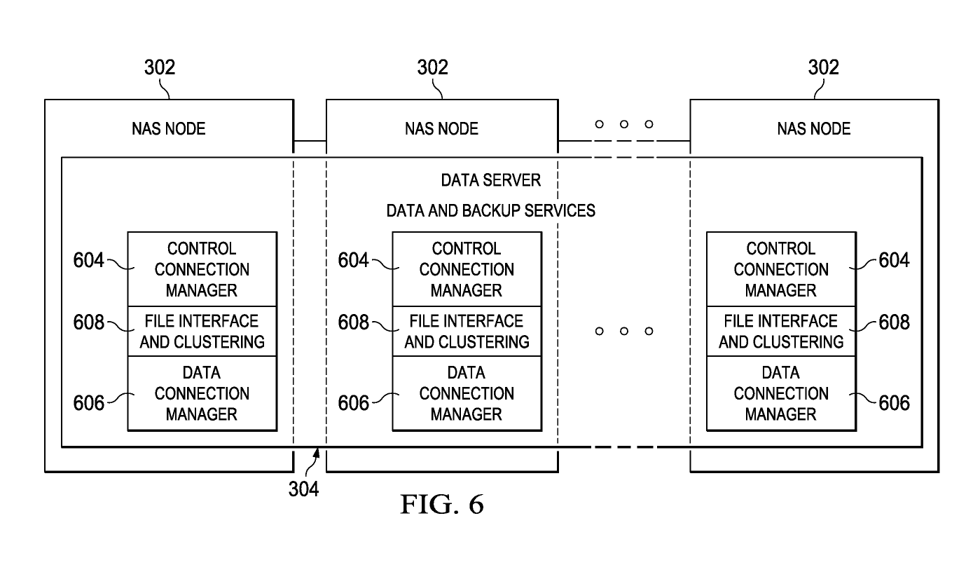

FIG. 6 illustrates selected components of NAS nodes 302 comprising a distributed NDMP data server 304, in accordance with embodiments of the present disclosure. As shown in FIG. 6, in embodiments of the present disclosure the various NAS nodes 302 of a cluster may comprise distributed NDMP data server 304, which may provide data and backup services for the cluster. Data server 304 may be cluster-wide and cluster-aware, thus permitting use in a scale-out storage cluster of NAS nodes 302. As shown in FIG. 6, the cluster-wide data server 304 may include control connection manager 604, data connection manager 606, and file interface and clustering 608. In some embodiments, data server 304 and its various components (e.g., control connection manager 604, data connection manager 606, and file interface and clustering 608) may comprise one or more programs of instructions configured to execute on one or more processors (e.g., one or more processors of the various NAS nodes 302).

As its name implies, control connection manager 604 may establish and/or manage control connections between DMA 312 and various NAS nodes 302. Similarly, data connection manager 606 may establish and/or manage data connections between various NAS nodes 302 and various backup devices 306.

File interface and clustering 608 may logically exist across the cluster of NAS nodes 302 and may process backup requests the cluster decide which node 302 should handle the request. For example, an incoming backup request for a resource may be load balanced to one of the NAS nodes 302 and based on the resource to be backed up will transfer the request to one of the available NAS nodes 302. The placement of a request will be based on the resource availability of NAS nodes 302, the locality or latency or cost of access to data for the resource to be backed up.

Accordingly, the cluster-wide NDMP data server decouples the control connection management and data streams over data connections, such that control connections and data connections may be independently placed among the NAS nodes 302 of a cluster to optimize cluster performance and backup performance. Decisions regarding the placement of control connections and data connections to a NAS node 302 may be made based on existing overall loads of the various NAS nodes 302 and the expected additional load after another connection is made.

To load balance control connections, a set of virtual identifiers (e.g., Internet Protocol addresses) may be defined. The number of such identifiers could equal the number of NAS nodes 302 associated with a cluster. Such identifiers may provide separate end points for DMAs 312 to connect for control connections on the cluster. The data server may then load balance based on individual identifiers to a NAS node 302 in order to balance connections among NAS nodes 302 of the cluster-wide data server 304.

For three-way configuration, for each individual backup request from DMAs 312, data server 304 may load balance outgoing connections to individual physical interfaces on NAS nodes 302 in response to such DMA requests. For each restore request, data server 304 may load balance incoming requests by providing the desired connection end-point in response to such request.

In embodiments in which DMA 312 supports resiliency of the control connection, and data server 304 supports restart, data server 304 may support rebalancing of data and control connections by forcing re-connections to desired interfaces after initial connections are made.

FIG. 7 illustrates a block diagram of an example information handling system 702, in accordance with embodiments of the present disclosure. An information handling system, for example those embodiments represented in FIG. 7, may be used to implement all of a portion of a NAS node 302, a backup device 306, DMA 312, or any other component set forth in the foregoing disclosure.

In some embodiments, information handling system 702 may be a server. In other embodiments, information handling system 702 may be a dedicated storage system such as, for example, NAS system or an external block storage controller responsible for operating on the data in a NAS cluster and sending and receiving data from other information handling systems coupled to the cluster. As depicted in FIG. 7, an information handling system 702 may include a processor 703, a memory 704 communicatively coupled to processor 703, and a network interface 706 coupled to processor 703.

A processor 703 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, a processor 703 may interpret and/or execute program instructions and/or process data stored in an associated memory 704 and/or another component of an information handling system 702.

A memory 704 may be communicatively coupled to an associated processor 703 and may include any system, device, or apparatus configured to retain program instructions and/or data for a period of time (e.g., computer-readable media). A memory 704 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to an information handling system 702 is turned off.

A network interface 706 may include any suitable system, apparatus, or device operable to serve as an interface between information handling system 702 and an external network (e.g., a local area network or other network). Network interface 706 may enable an information handling system 702 to communicate with an external network using any suitable transmission protocol (e.g., TCP/IP) and/or standard (e.g., IEEE 802.11, Wi-Fi). In certain embodiments, network interface 706 may include a network interface card (“NIC”). In the same or alternative embodiments, network interface 706 may be configured to communicate via wireless transmissions. In the same or alternative embodiments, network interface 706 may provide physical access to a networking medium and/or provide a low-level addressing system (e.g., through the use of Media Access Control addresses). In some embodiments, network interface 706 may be implemented as a local area network (“LAN”) on motherboard (“LOM”) interface.

In addition to a processor 703, a memory 704, and a network interface 706, an information handling system 702 may include one or more other information handling resources. An information handling resource may include any component system, device or apparatus of an information handling system, including without limitation a processor (e.g., processor 703), bus, memory (e.g., memory 704), input-output device and/or interface, storage resource (e.g., hard disk drives), network interface (e.g., network interface 706), electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

Although the present disclosure has been described in detail, it should be understood that various changes, substitutions, and alterations can be made hereto without departing from the spirit and the scope of the disclosure as defined by the appended claims.

What is claimed is:

1. A storage system comprising:
a storage cluster comprising a plurality of network attached storage nodes;
one or more backup devices communicatively coupled to the storage cluster; and
a cluster-wide data server executing on the plurality of network attached storage nodes and configured to manage communication of backup data between the plurality of network attached storage nodes and the one or more backup devices.

2. The storage system of claim 1, the cluster-wide data server configured to load balance control connections between a data management application and the plurality of network attached storage nodes, the control connections for backup operations of data between the plurality of network-attached storage nodes and the one or more backup devices.

3. The storage system of claim 2, the cluster-wide data server further configured to:
assign identifiers to each of the network attached storage nodes; and
load balance control connections among the identifiers.

4. The storage system of claim 1, the cluster-wide data server configured to load balance data connections between the plurality of network attached storage nodes and the one or more backup devices, the data connections for backup operations of data between the plurality of network-attached storage nodes and the one or more backup devices.

5. The storage system of claim 1, wherein the one or more backup devices are directly coupled to the plurality of network attached storage nodes.

6. The storage system of claim 1, wherein the one or more backup devices are coupled to the plurality of network attached storage nodes via a storage area network.

7. The storage system of claim 1, wherein the one or more backup devices are coupled to the plurality of network attached storage nodes via a local area network.

8. A method comprising:
instantiating a cluster-wide data server to execute on a plurality of network attached storage nodes defining a storage cluster; and
managing communication of backup data between the plurality of network attached storage nodes and one or more backup devices communicatively coupled to the storage cluster.

9. The method of claim 8, further comprising load balancing control connections between a data management application and the plurality of network attached storage nodes, the control connections for backup operations of data between the plurality of network-attached storage nodes and the one or more backup devices.

10. The method of claim 9, further comprising:
assigning identifiers to each of the network attached storage nodes; and
load balancing control connections among the identifiers.

11. The method of claim 8, further comprising load balancing data connections between the plurality of network attached storage nodes and the one or more backup devices, the data connections for backup operations of data between the plurality of network attached storage nodes and the one or more backup devices.

12. The method of claim 8, wherein the one or more backup devices are directly coupled to the plurality of network attached storage nodes.

13. The method of claim 8, wherein the one or more backup devices are coupled to the plurality of network attached storage nodes via a storage area network.

14. The method of claim 8, wherein the one or more backup devices are coupled to the plurality of network attached storage nodes via a local area network.

15. An article of manufacture comprising:
a computer readable medium; and
computer-executable instructions carried on the computer readable medium, the instructions readable by one or more processors, the instructions, when read and executed, for causing the one or more processors to:
instantiate a cluster-wide data server to execute on a plurality of network attached storage nodes defining a storage cluster; and
manage communication of backup data between the plurality of network attached storage nodes and one or more backup devices communicatively coupled to the storage cluster.

16. The article of claim 15, the instructions for further causing the one or more processors to load balance control connections between a data management application and the plurality of network attached storage nodes, the control connections for backup operations of data between the plurality of network-attached storage nodes and the one or more backup devices.

17. The article of claim 16, the instructions for further causing the one or more processors to:
assign identifiers to each of the network attached storage nodes; and
load balance control connections among the identifiers.

18. The article of claim 15, the instructions for further causing the one or more processors to load balance data connections between the plurality of network attached storage nodes and the one or more backup devices, the data connections for backup operations of data between the plurality of network attached storage nodes and the one or more backup devices.

19. The article of claim 15, wherein the one or more backup devices are directly coupled to the plurality of network attached storage nodes.

20. The article of claim 15, wherein the one or more backup devices are coupled to the plurality of network attached storage nodes via a storage area network.

21. The article of claim 15, wherein the one or more backup devices are coupled to the plurality of network attached storage nodes via a local area network.
